(19) United States
(12) Patent Application Publication
(10) Pub. No.: US 2009/0271235 A1
(43) Pub. Date: Oct. 29, 2009

(54) APPARATUS AND METHOD FOR GENERATING SURVIVAL CURVE USED TO CALCULATE FAILURE PROBABILITY

(75) Inventor: Kazuto KUBOTA, Kawasaki-shi (JP)

Correspondence Address: Ohlandt, Greeley Ruggiero & Perle, L.L.P, 10th Floor, One Landmark Square, Stamford, CT, 06901-2682, US

(73) Assignee: KABUSHIKI KAISHA TOSHIBA

(21) Appl. No.: 12/408,923

(22) Filed: Mar. 23, 2009

(30) Foreign Application Priority Data
Apr. 25, 2008 (JP) 2008-116128

(51) Int. Cl. G06Q 10/00

(52) U.S. Cl. 705/7

(57) ABSTRACT

A part fault table indicating the number of days used, a fault flag and a first weight is generated for each of plural parts. A survival curve and a hazard function for each of the plural parts are also generated. Then, convergence is determined by calculating a hazard value using the hazard function for each part in the same group, calculating a second weight by normalization using the hazard value of each part and comparing the first and second weight with each other. Finally, a control operation is performed in such a manner that the convergence determination is terminated by outputting the survival curve or updates the first weight with the second weight, while a new survival curve and a new hazard function are generated from the part fault table using the updated first weight, after which the convergence determination is determined again.

### CROSS-REFERENCE TO RELATED APPLICATIONS

This application is based upon and claims the benefit of priority from prior Japanese Patent Application No. 2008-116128, filed Apr. 25, 2008, the entire contents of which are incorporated herein by reference.

### BACKGROUND OF THE INVENTION

1. Field of the Invention

The present invention relates to an apparatus and a method for generating a survival curve used for calculation of failure probability of parts making up a device.

2. Description of the Related Art

As a method for predicting the failure probability of the parts making up a device, a technique called survival time analysis is available. In the survival time analysis, the relation between the number of survival days and the survival probability of a given part is calculated from plural failure history data of the particular part. In the case where the survival probability of a part 300 days layer is 0.8, for example, it indicates that an average of 200 of 1000 parts are out of order 300 days later. This failure probability can be utilized, for example, to form a part replace plan, and therefore, the failure probability calculation with a higher accuracy is a critical problem.

In the survival time analysis, the number of days before N identical parts come to develop a fault is input as data. The number of days fluctuates even for the same part, and therefore, is plotted as a distribution. Some parts may not develop any fault during the observation period. The data on these parts are called censored data and used for the survival time analysis as the information indicating that no fault has occurred before the lapse of the particular number of days. The output data is the function of the number of days called the reliability (survival curve). The output reliability gives the probability that a part has not developed a fault upon the lapse of the particular number of days.

The survival time analysis is described by Elisa T. Lee in “Statistical Methods for Survival Data Analysis Third Edition”, Wiley Interscience, 2003, Chapters 1, 2 and 7.

The faulty part causing a device failure may not be identified, in which case the repair engineer may be required to replace all the parts that may have developed a fault. In the information on the replace work obtained in such a case, which one of the replaced parts has actually developed a fault remains unknown, and therefore, the survival curve described above cannot be generated. In the case where a fault flag is determined on the assumption that all the parts have developed a fault, the survival curve would be calculated in a form indicating a higher tendency to develop a fault.

### BRIEF SUMMARY OF THE INVENTION

One aspect of the present invention relates to a survival curve generating apparatus. The apparatus includes a first generating unit which generates a replace record table indicating, for each of a plurality of parts, an identifier of a part, the number of days the part is used, a fault flag assuming a first value indicating that the part develops or relates to a fault and a second value indicating that the part develops no fault, a group number assuming the same value as other parts related to the same fault and a first weight indicating a uniform degree of effect that the part has on the same fault; a second generating unit which generates a part fault table indicating, for each of the parts from the replace record table, the number of days used, the fault flag and the first weight; a third generating unit which generates a survival curve and a hazard function based on the part fault table for each of said plurality of parts; a determining unit which calculates, for each of the parts in the same group, a hazard value using the hazard function, divides the hazard value of each part by a total hazard value of all the parts in the same group thereby to calculate a second weight, and determines convergence by comparing the first weight and the second weight with each other; and a control unit which performs a control operation in such a manner that: the operation is ended by outputting the survival curve when a first result is obtained from the convergence determination; the first weight is updated with the second weight when a second result is obtained from the convergence determination, and the convergence is determined again by the determining unit after a new survival curve and a new hazard function are generated from the part fault table by the third generating unit using the updated first weight.

### BRIEF DESCRIPTION OF THE SEVERAL VIEWS OF THE DRAWING

FIG. 1 is a block diagram showing a survival curve generating apparatus according to a first embodiment;

FIG. 2 is a block diagram showing the hardware for generating the survival curve;

FIG. 3 is a diagram showing a maintenance log;

FIG. 4 is a diagram showing a replace record table;

FIG. 5 is a diagram showing a replace record table after calculating a first weight;

FIG. 6 is a diagram showing a part fault table;

FIG. 7 is a graph showing the survival curve;

FIG. 8 is a graph showing a hazard function;

FIG. 9 is a flowchart showing the steps of the process executed according to the first embodiment;

FIG. 10 is a block diagram showing a survival curve generating apparatus according to a second embodiment;

FIG. 11 is a diagram showing a maintenance log;

FIG. 12 is a diagram showing a replace record table;

FIG. 13 is a diagram showing a set of faulty parts;

FIG. 14 is a diagram showing a set of frequent faulty parts;

FIG. 15 is a diagram showing an inspector ability table;

FIG. 16 is a diagram showing a part fault knowledge table;

FIG. 17 is a flowchart showing the steps of the process executed for generating a set of frequent faults;

FIG. 18 is a diagram showing a method of calculating wcnt_eg;

FIG. 19 is a block diagram showing a survival curve generating apparatus according to a third embodiment;

FIG. 20 is a block diagram showing a survival curve generating apparatus according to a fourth embodiment as a modification of the first embodiment;

FIG. 21 is a block diagram showing a survival curve generating apparatus according to the fourth embodiment as a modification of the second embodiment; and

FIG. 22 is a block diagram showing a survival curve generating apparatus according to the fourth embodiment as a modification of the third embodiment.

### DETAILED DESCRIPTION OF THE INVENTION

### First Embodiment

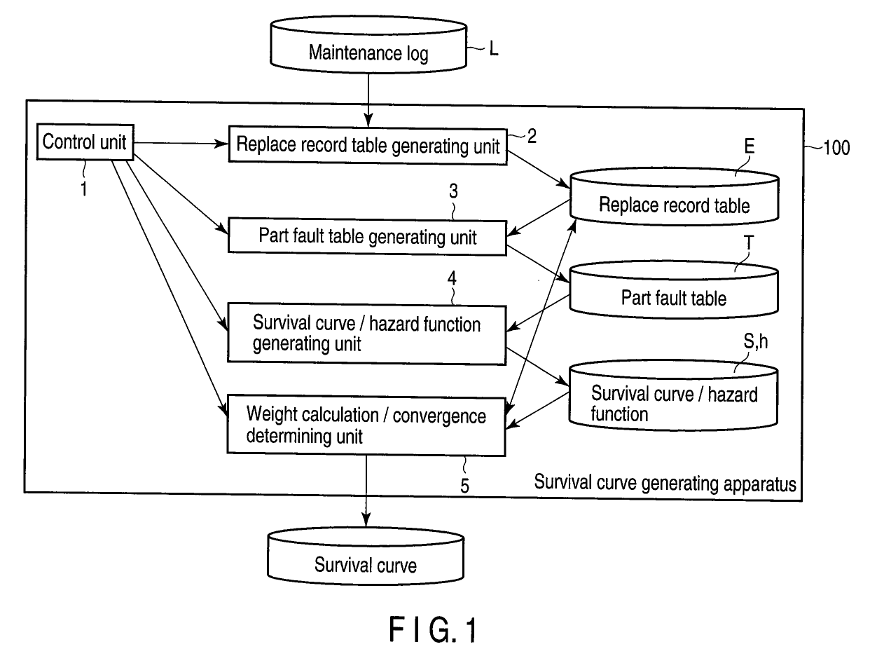

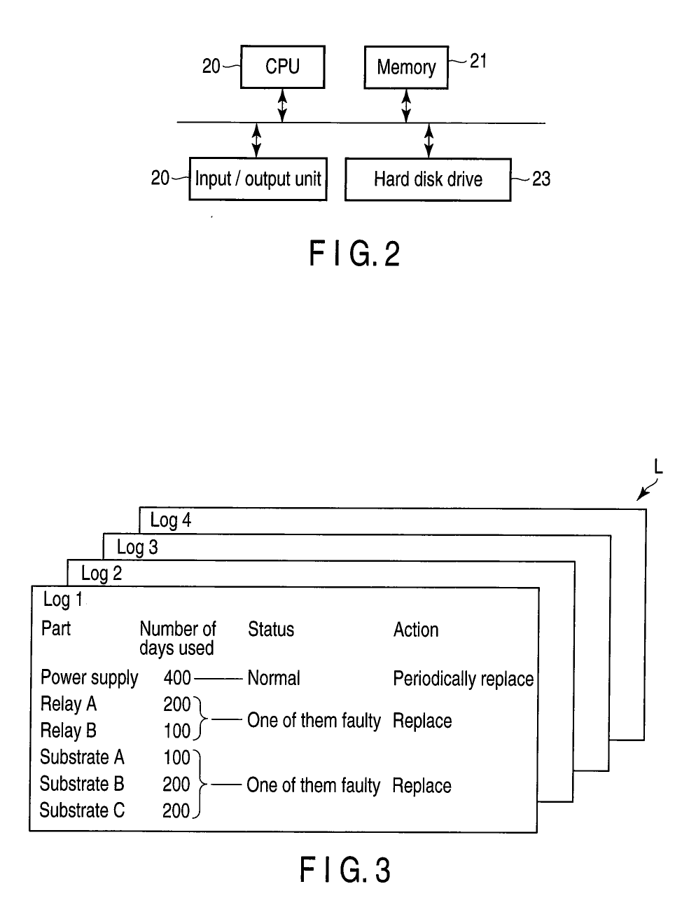

A survival curve generating apparatus 100 shown in FIG. 1 includes a replace record table generating unit 2 for generating a replace record table E from maintenance logs L, a part fault table generating unit 3 for generating a part fault table T from the replace record table E, a survival curve/hazard function generating unit 4 for generating the survival curve and the hazard function from the part fault table T, a determining unit 5 for determining action convergence by calculating the weight from the survival curve and the hazard function, and a control unit 1 for outputting the survival curve upon convergence determination and updating the weight of the replace record table E in the absence of convergence determination. The survival curve generating apparatus 100 can thus be realized using the survival curve generating hardware shown in FIG. 2. The control unit 1, the replace record table generating unit 2, the part fault table generating unit 3, the survival curve/hazard function generating unit 4 and the weight calculation/convergence determining unit 5 shown in FIG. 1 are stored as a program on a memory 21 and executed by a CPU 20.

The maintenance logs L are input from an input/output unit 22 and stored in a hard disk drive 23, and under the control of the control unit 1, processed by the replacement record table generating unit 2, the part fault table generating unit 3, the survival curve/hazard function generating unit 4 and the weight calculation/convergence determining unit 5. A replace record table E, a part fault table T, and a survival curve/hazard function S, h are generated during this process, and stored on the memory 21 or the hard disk drive 23. The survival curve finally generated is stored in the hard disk drive 23 and output through the input/output unit 22.

An example of the maintenance logs L is shown in FIG. 3. Each log of the maintenance logs L is assigned a serial number, and each computerized log makes up a record of one maintenance session. Each log contains the description of the ID (name) of the part replaced and the number of days it is used. Further, in the case where the part is replaced due to a fault, the fact is described as the status and action taken for the particular part. For example, the status is described as “fault” and the action as “replace”. The record may contain the description indicating that the part, though normal in status, is replaced periodically. In such a case, the status is described as “normal” and the action as “periodical replacement”. As described above, the cause of a fault may not be traced in some case. In the log 1 of FIG. 3, for example, assume that which has developed a fault is unknown, the relay A or the relay B, but it is determined that one of the relays and one of substrates A, B and C have developed a fault. In this case, the status is described as “one has developed a fault” over plural parts and the action as “replace”.

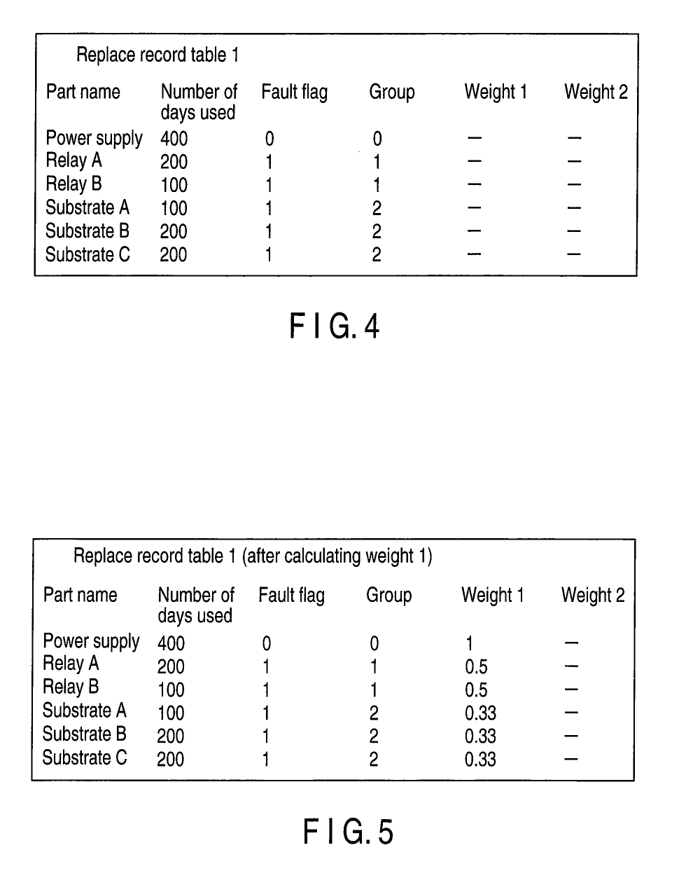

The replace record table E is generated for each log from the maintenance log L by the replace record table generating unit 2. The replace record table E has fields including the part name, number of days used, fault flag, group, weight 1 and weight 2. FIG. 4 shows one replace record table 1 generated from the log 1 of the maintenance log L shown in FIG. 3. The “part name” and the “number of days used” are copied directly from the log 1. The “fault flag” for the part liable to develop a fault is set to 1, and other fault flags to 0.

The “group” that has not developed a fault is set to 0, and the parts associated with the same fault are assigned a group number of the same group. In the case of FIG. 4, for example, the relays A and B are associated with the same fault, and therefore, assigned the group number 1, while the substrates A, B and C which are associated with different faults are assigned the group number 2. The weights 1 and 2 are each assigned the value 1 for the part having no fault, and for the part likely to develop a fault, indicate the degree of effect that the particular part may have on the particular fault. The degree of effect is 1 in total. According to this embodiment, the replace record table generating unit 2 assigns the equal degree of fault effect on the parts to the weight 1 as an initial weight. Specifically, upon judgment that one of n parts has a fault, for example, the weight of the particular n parts is all 1/n. FIG. 5 shows the replace record table after calculation of the weight 1. The weight of the relays A and B is set to 0.5 and that of the substrates A, B and C to 0.33.

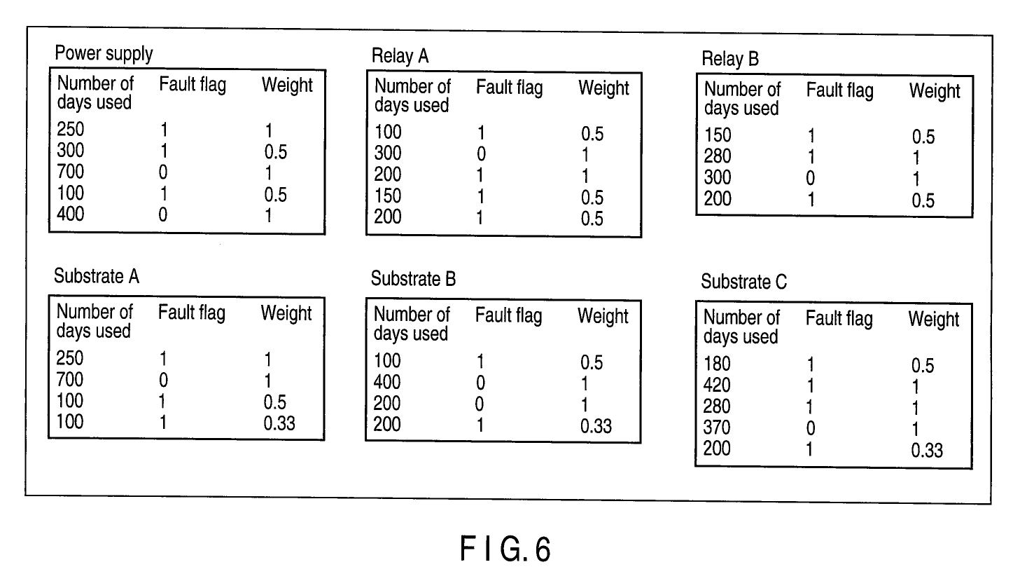

The part fault table T is generated by the part fault table generating unit 3 from the replace record table E for all the parts. FIG. 6 shows a part replace table for six types of parts. The entries added based on the replace record table 1 of FIG. 5 are indicated in italic letters. The number of days used, the fault flag and the weight 1 are each copied to the part fault table T.

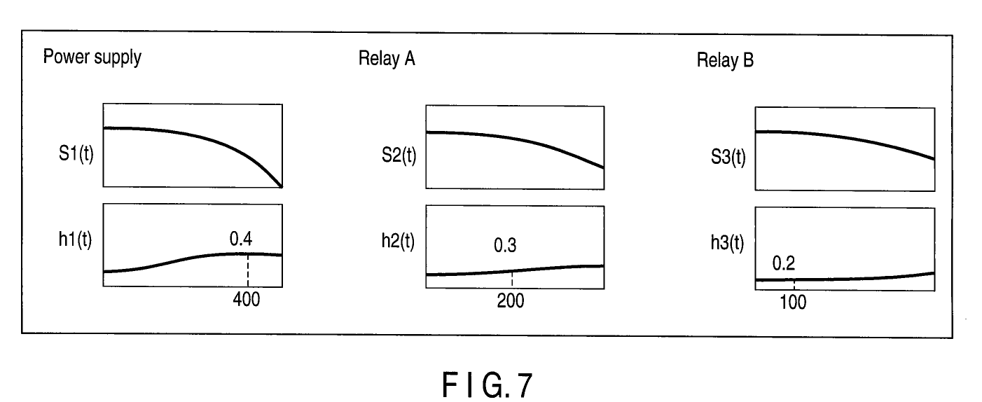

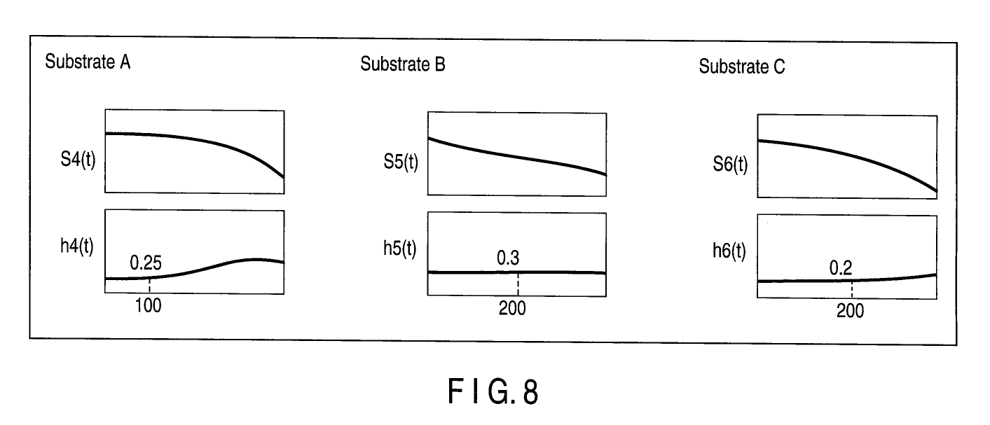

The survival curve shown in FIG. 7 and the hazard function shown in FIG. 8 are generated from the part fault table T by the survival curve/hazard function generating unit 4 for all the parts. To generate the Weibull curve as a survival curve, for example, the parameter estimation method can be used in which the two parameters (the shape parameter m and the scale parameter η) of the Weibull distribution are estimated from the input data.

The method of determining the survival curve, i.e. the reliability using the Weibull distribution will be explained. In the method using the Weibull distribution, the reliability is modeled by the Weibull distribution so that the two parameters (the shape parameter m and the scale parameter η) having the Weibull distribution are estimated from the input data (parameter estimation method). Let the probability density function of the Weibull distribution be f(t, m, η) and the reliability R(t, m, η). Then, the likelihood function can be set as follows.

$$L ( m , η ) = {\prod }_{i = 1}^{r} f ( {t}_{i} , m , η ) {\prod }_{j = 1}^{N - r} R ( {t}_{j} , m , η )$$

where n is the number of parts, and r the number of parts having no fault. The logarithm of this likelihood function L is set to 0 by partial differentiation with the shape parameter m and the scale parameter η, and the convergence is calculated. In this way, the values of the shape parameter m and the scale parameter η can be estimated. In other words, the survival curve can be obtained. The probability density function f(t, m, η) and the reliability R(t, m, η) can be expressed as follows.

$$L ( m , η ) = {\prod }_{i = 1}^{r} f ( {t}_{i} , m , η ) {\prod }_{j = 1}^{N - r} R ( {t}_{j} , m , η )$$

The hazard function shown in FIG. 8 indicates the probability that the part having developed no fault before time t develops a fault at time t. The hazard function can be described using the parameter calculated at the time of generating the Weibull curve. In other words, the hazard function is not required to be calculated anew.

The hazard function thus generated is used to calculate the weight 2 of the replace record table (as the process thereof will be described in detail later). This process is executed by the weight calculation/convergence determining unit 5. Further, the weight calculation/convergence determining unit 5, upon judgment that the weight calculation is converged by making comparison between weight 1 and weight 2, outputs, as the calculation result, the latest survival curve generated by the past process. Upon judgment that no such convergence occurs, on the other hand, the weight calculation/convergence determining unit 5 copies the weight 2 of the replace record table to the weight 1 and notifies the control unit 1 that no convergence has occurred. After that, the control unit 1 repeats the process of generating a series of the survival curves and updating the replace record table.

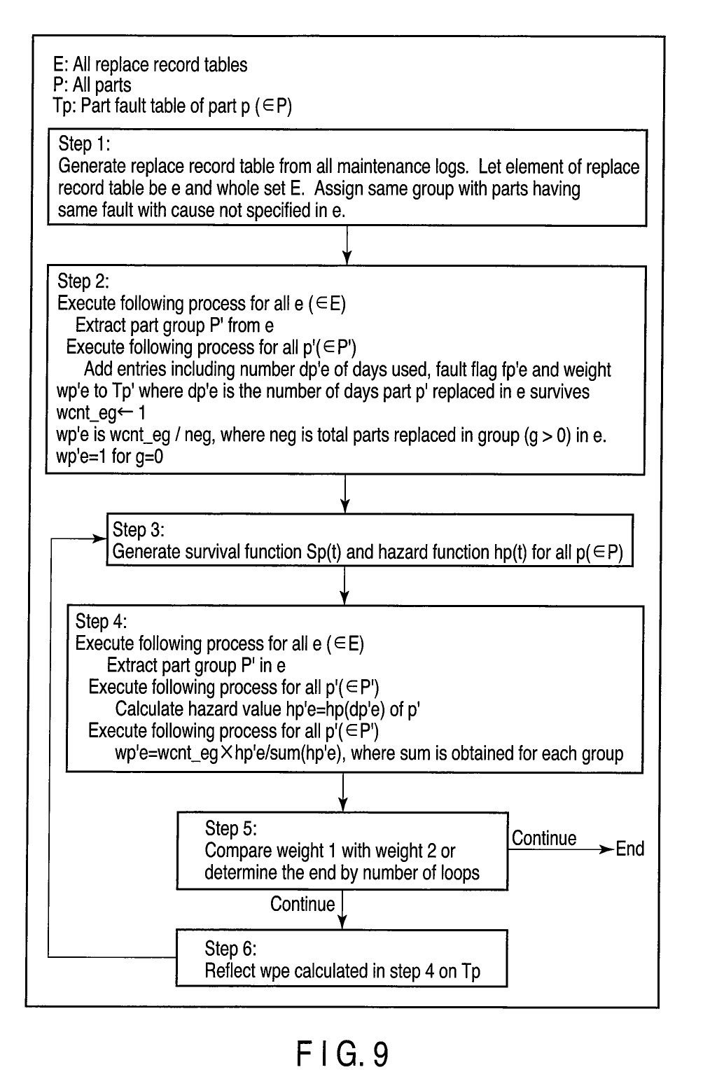

This process will be described below with reference to the flowchart of FIG. 9.

Now, let E be the replace record table of all the parts, e the element of all the replace record tables E, P all the parts, p the element of all the parts P, Tp the part fault table for the part p, Sp(t) the survival curve for the part p, and Hp(t) the hazard function for the part p.

In step 1, the replace record table E is generated from the maintenance log L. The part name, the number of days used, the fault flag and the group in the replace record table E are generated by the method described above.

In step 2, the weight 1 is calculated for all the replace record table e (ε E). For the group of 0, i.e. in the case free of a fault, the weight 1 is set to 1, and otherwise, wcnt_eg is divided by the number of the group members (wp′e=wcnt_eg/neg, where neg is the total of the parts replaced in the group (g>0) in the replace record table e. In the case where g is 0, wp′e=1), where wcnt eg is assumed to be 1, for example.

In step 3, the survival curve Sp(t) and the hazard function Hp(t) are generated for each p (ε P).

In step 4, the weight 2 is calculated for the entire part fault table. This weight 2 is calculated in such a manner that the hazard value is calculated using the hazard function for each part in the same group and the hazard value of each part is divided by the total of all the hazard values in the same group. More specifically, the weight 2 is determined by first calculating the failure rate (hazard value) hp′e=hp (dp′e) of the parts p′ (ε P′ indicating all the parts included in the replace record table e) upon the lapse of the number dp′e of the days used and then calculating wp′e=wcnt_eg×hp′e/sum (hp′e), where sum (hp′e) is the total value hp′e in the same group, and wp′e the weight 2 of the replace record table e. Incidentally, the weight 2 of the parts of group number 0, i.e. the parts free of a fault is set to weight 1. Also, the parts for which the number of the group member is 1 have also the weight 1.

In step 5, the weight 1 and the weight 2 are compared with each other, and in the absence of any difference, the process is assumed to have converged and the process end is determined. This comparison can be made by judging whether the square sum of the difference vectors, for example, is larger or smaller than a threshold value or not. As an alternative, the process may be assumed to have ended also in the case where the number of loops of the process from steps 3 to 5 exceeds a specified value. Upon completion of the process, the latest survival curve Sp(t) is output. Upon judgment that the process is to be continued, on the other hand, the control unit 1 updates the weight 1 by copying all the weight 2 of the replace record table to the weight 1 thereby to return the process to step 3.

The process described above increases the weight of a part of which the fault has thus far been unknown and which is liable to have a fault, while decreasing the weight of a part of which the fault has thus far been unknown and which is not liable to have a fault. Even in the case where a faulty part causing a device failure is not specified, therefore, the survival curve used for calculation of the failure probability can be generated based on the replace work information also in such a case as described above.

### Second Embodiment

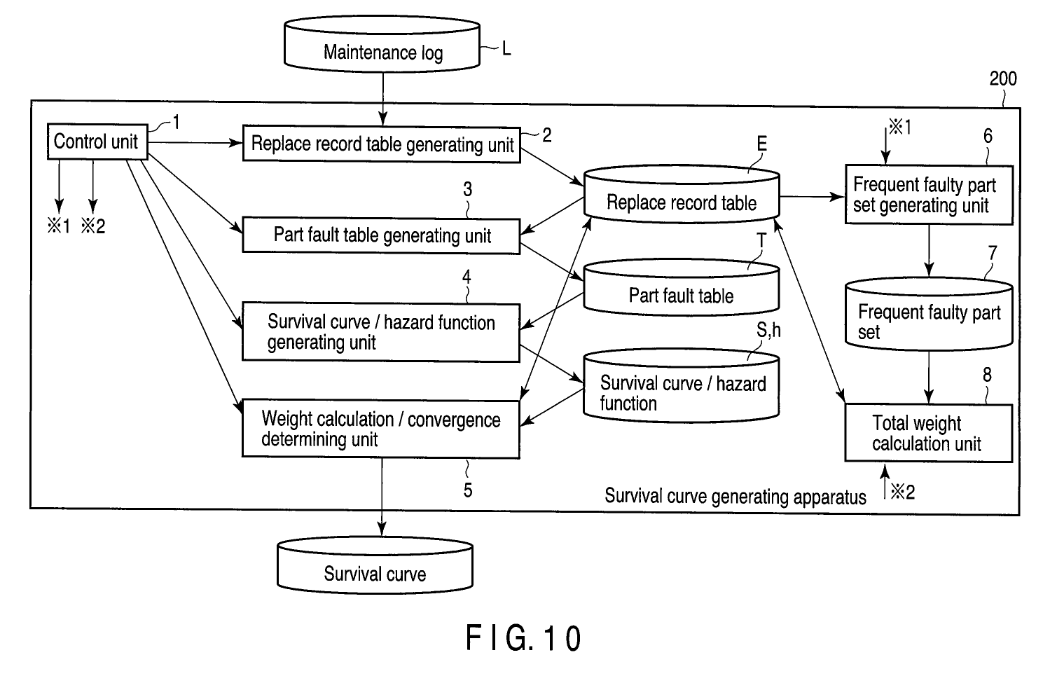

A survival curve generating apparatus 200 according to the second embodiment shown in FIG. 10, in addition to the configuration of the first embodiment, includes a frequent faulty part set generating unit 6 for generating a frequent faulty part set 7 from the replace record table E and a total weight calculation unit 8 for calculating the total weight from the frequency faulty part set 7 and the replace record table E and determining the total weight used for the weight 1 of the replace record table E.

The survival curve generating apparatus 200 can be also implemented using the survival curve generating hardware shown in FIG. 2. The frequent faulty part set generating unit 6 and the total weight calculation unit 8 are stored on the memory 21 and executed by the CPU 20. Also, the frequency faulty part set 7 generated during the process is stored on the memory 21 or the hard disk drive 23.

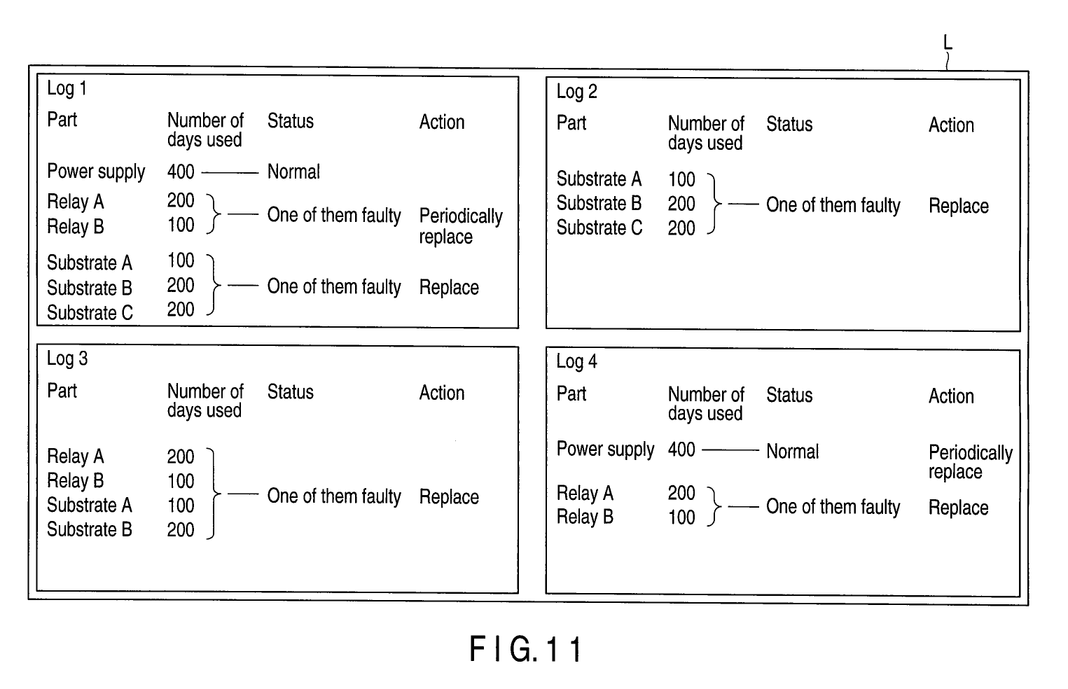

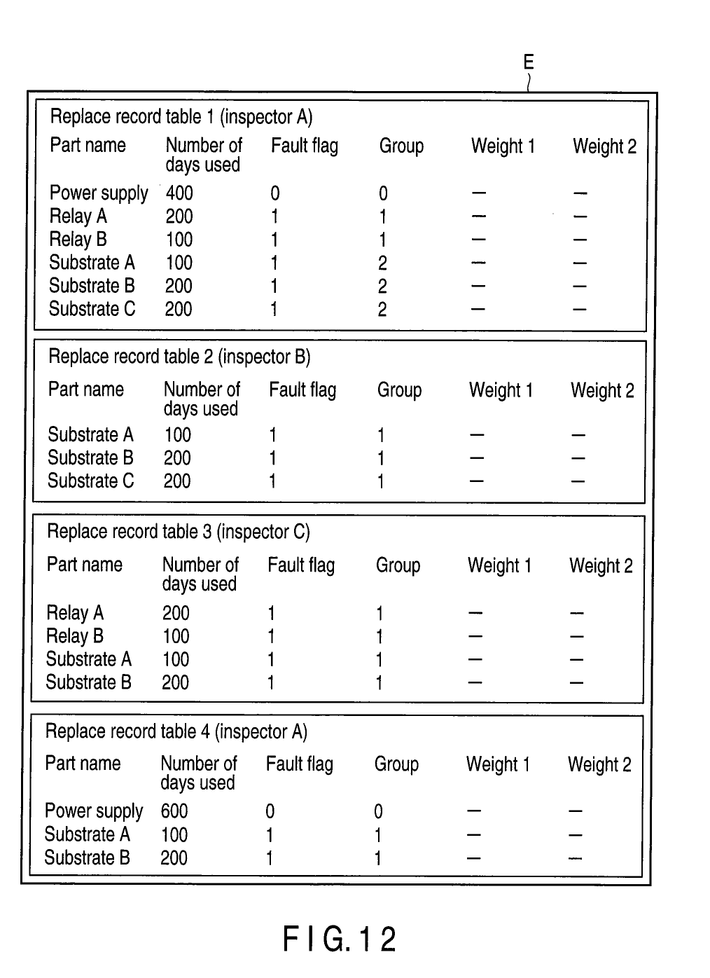

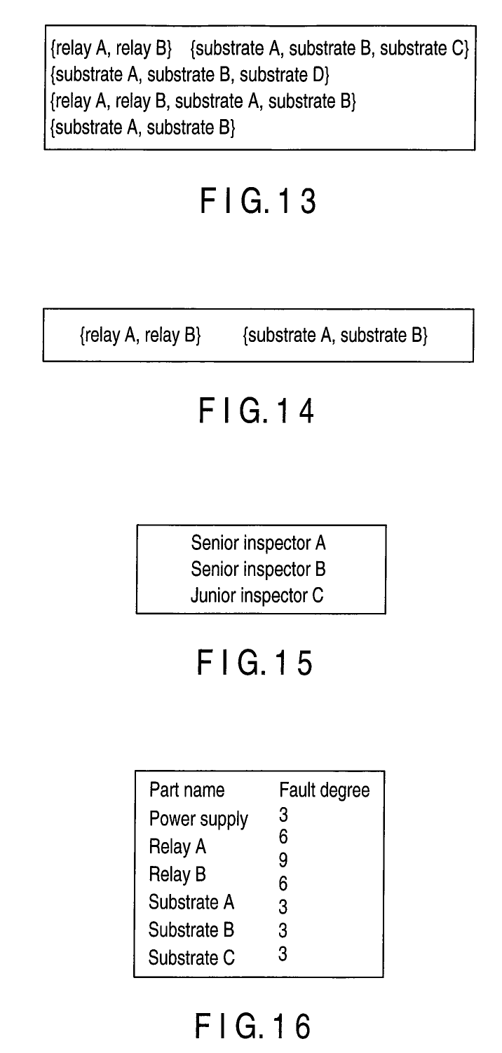

According to the second embodiment, after the replace record table generating unit 2 generates the replace record table E, the frequent faulty part set generating unit 6 generates the frequent faulty part set 7. FIG. 11 shows the maintenance log L for four sessions. The replace record table E generated from this log L is shown in FIG. 12. Using the replace record table E, the frequent faulty part set generating unit 6 first generates a faulty part set as shown in FIG. 13. This is formed of the parts, extracted by group, which are liable to have been replaced due to a fault. Next, the association rule extraction is executed for this set thereby to extract the frequent faulty part set which frequently appears in all the sets. As for the association rule extraction, the technique described in Michael J. A. Berry, et al. “Data Mining Method . . . Customer Analysis for Business, Marketing and Customer Support”, for example, can be used. The extracted frequent part sets are shown in FIG. 14. Probably, these sets are independently involved in the fault. The faulty part set including plural frequent faulty part sets, therefore, is judged to have a high possibility of having plural faulty parts therein. In step 2 shown in FIG. 9, therefore, wcnt_eg is not always set (first embodiment) to 1, but the total weight calculation unit 8 counts the number of the frequent faulty part sets for each group, and by setting the particular number, calculates the weight 1. In the case where no frequent faulty part set is included in the group, however, wcnt_eg is set to 1.

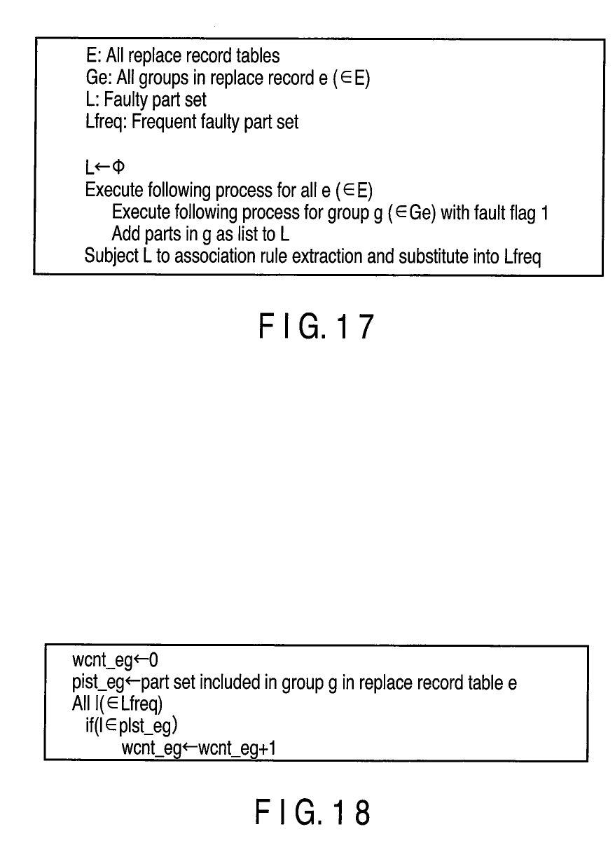

The flowchart for generating the frequent fault set is shown in FIG. 17. This process is executed after step 1 shown in FIG. 9. In FIG. 17, the faulty group g in each fault record table e is added to the faulty part set L and the association rule extraction is executed for L thereby to generate the frequent faulty part set Lfreq.

Next, FIG. 18 shows a method of calculating wcnt_eg in step 2. From the faulty part set of the fault group g in each fault record table e, the frequent faulty part sets are extracted one by one sequentially from Lfreq, and in the case where the particular one frequent faulty part set is included in the faulty part set, 1 is added to wcnt_eg.

According to the second embodiment, assume that plural causes of the fault may exist and that the inspector estimates that the cause is single. The survival curve can be generated taking the possibility of the presence of plural fault causes into consideration.

### Third Embodiment

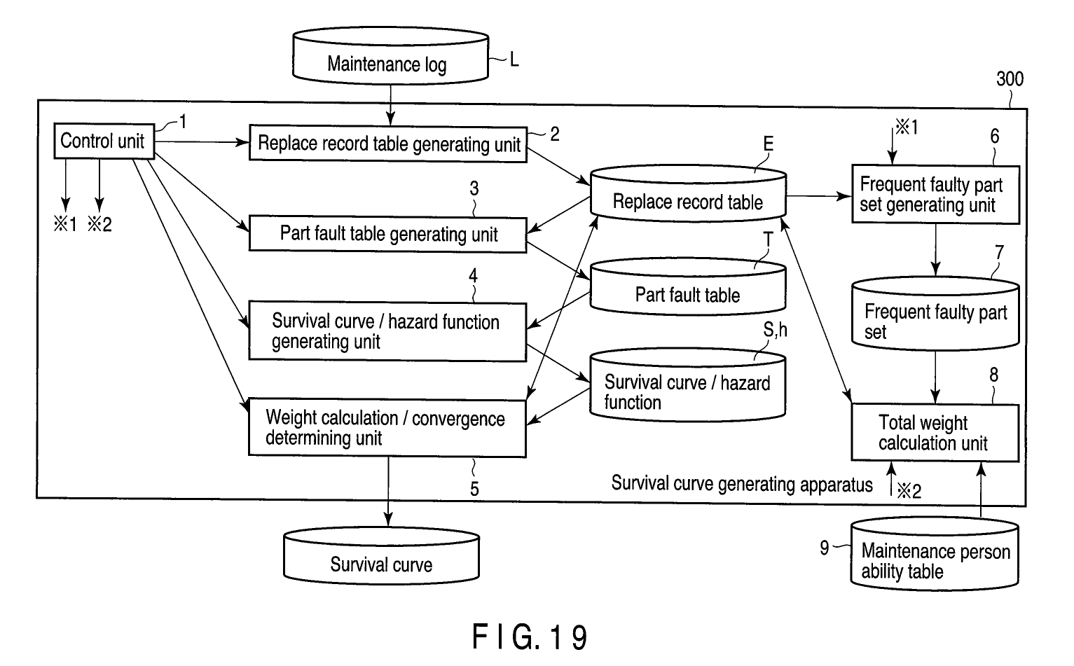

A survival curve generating apparatus 300 shown in FIG. 19, in addition to the configuration of the second embodiment, further including a maintenance person ability table 9, is so configured that the total weight calculation unit 8 calculates the total weight from the frequent faulty part set 7, the replace record table E and the maintenance person ability table 9 thereby to determine the total weight of the replace record table E.

The survival curve generating apparatus 300 can also be realized by use of the survival curve generating hardware shown in FIG. 2. The survival curve generating apparatus 300 shown in FIG. 19, in addition to the survival curve generating apparatus 200 shown in FIG. 10, uses the maintenance person ability table 9, which is placed on the hard disk drive 23 or the memory 21 through the input/output unit of FIG. 2 and accessed during the process.

According to the third embodiment, the total weight calculation unit 8 according to the second embodiment accesses the inspector ability table shown in FIG. 15, so that the weight is not recalculated for the replace record for the maintenance log L generated by a senior inspector while the weight is recalculated for the replace record for the maintenance log L generated by a junior inspector. This is by reason of the assumption that the maintenance log L generated by the senior inspector probably correctly describes the relation between the part and the fault while the maintenance log L generated by the junior inspector is liable to be erroneous.

According to the third embodiment, especially in the presence of a number of causes of a fault, a greater importance is attached to the part replace log generated by the senior inspector, thereby making it possible to suppress the reduction in accuracy of the survival curve generation in the case where the erroneous part replace log generated by the junior inspector is included.

### Fourth Embodiment

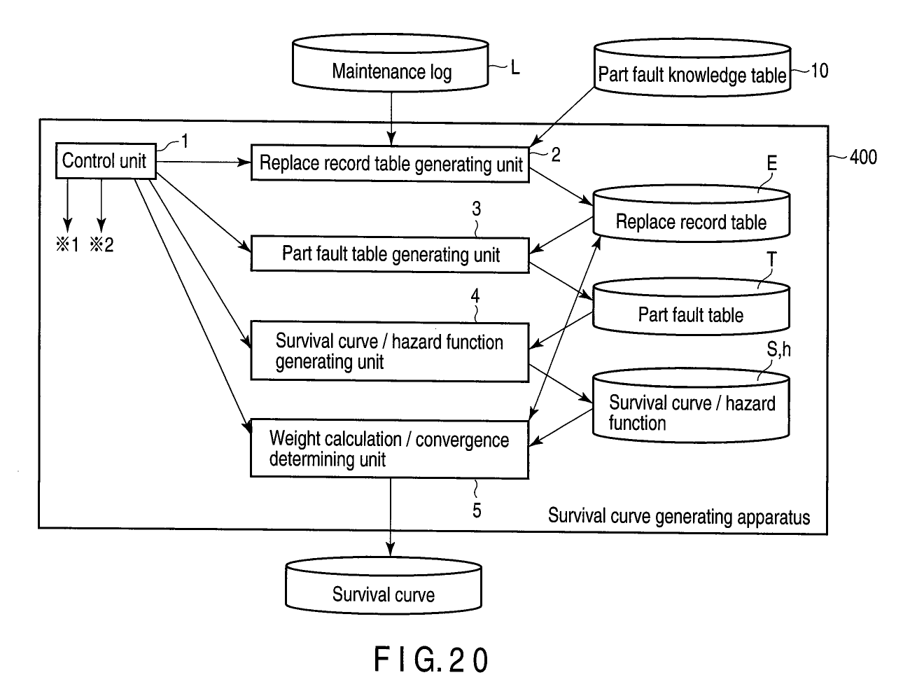

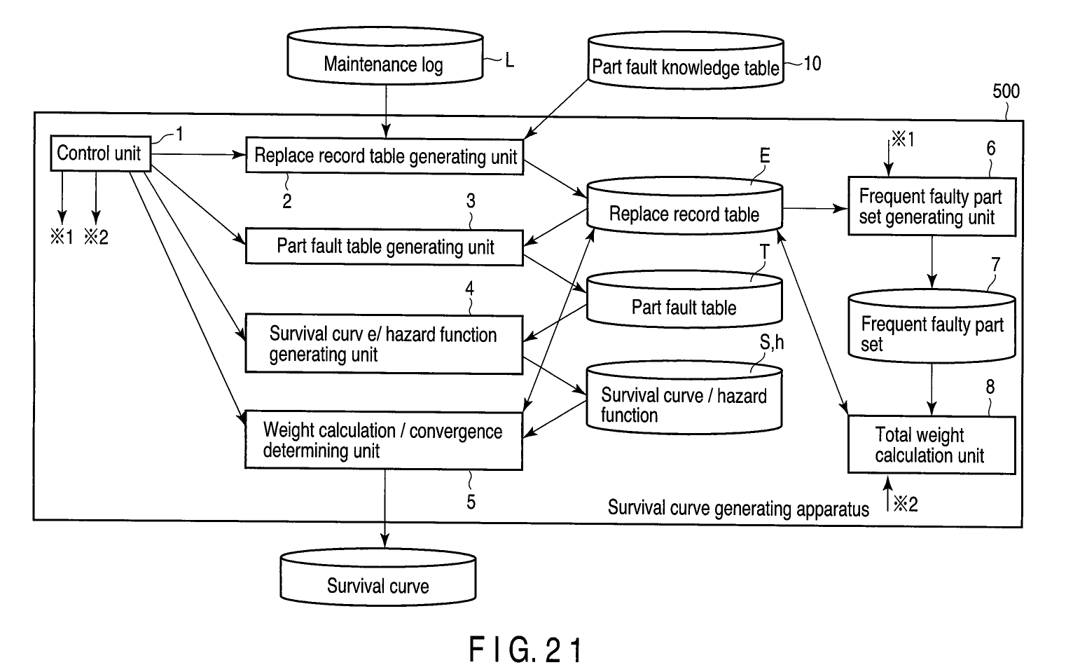

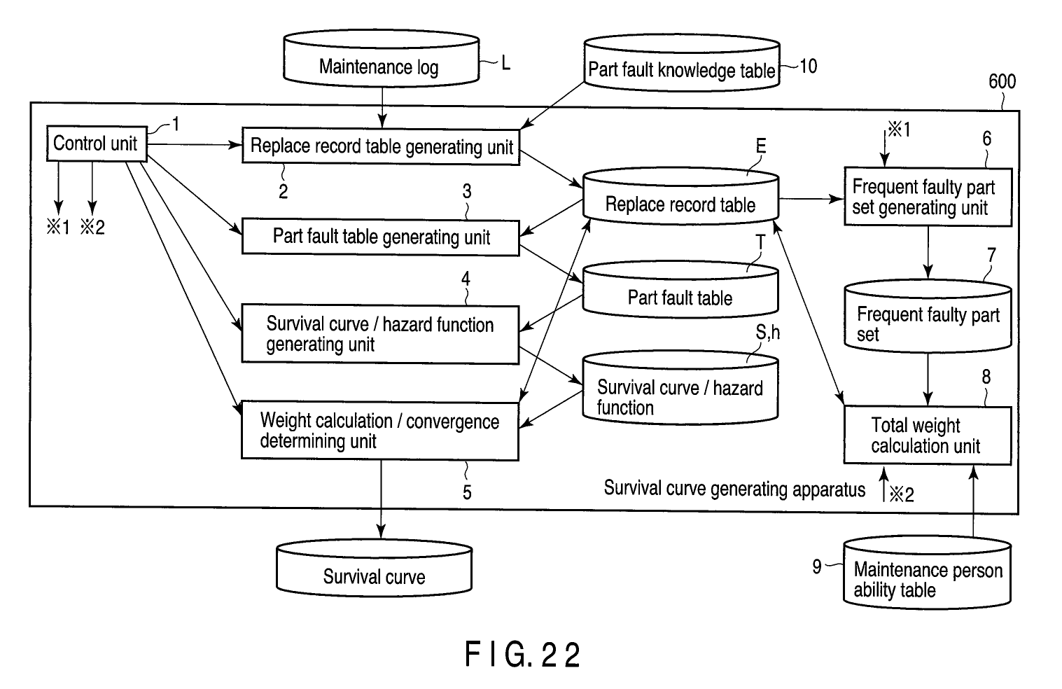

The fourth embodiment represents a modification of each of the first to third embodiments. Survival curve generating apparatuses 400, 500, 600 according to the first to third embodiments having the configurations shown in FIGS. 20 to 22, respectively, further including a part fault knowledge table 10, are so configured that the replace record table generating unit 2 generates the replace record table E based on the maintenance log L and the part fault knowledge table 10. The survival curve generating apparatuses 400, 500, 600 can also be realized by use of the survival curve generating hardware shown in FIG. 2. The part fault knowledge table 10 is input from the input/output unit and, held on the hard disk drive 23 or the memory 21, accessed during the process.

An example of the part fault knowledge table 10 is shown in FIG. 16. This table is formed of each part name and the degree of fault in pair with the degree of fragility in the number of points. This table is determined, for example, by the consultation between the inspectors. In the process executed by the fault record table generating unit according to the first, second or third embodiment, the weight 1 is distributed in accordance with the fault degree ratio shown in the part fault knowledge table 10. The weight 1 of the replace record table 1 shown in FIG. 4, for example, can be calculated as follows:

Weight 1 of relay A=6/(6+9)=0.4

Weight 1 of relay B=9/(6+9)=0.6

Weight 1 of substrate A=6/(6+3+3)=0.5

Weight 1 of substrate B=3/(6+3+3)=0.25

Weight 1 of substrate C=3/(6+3+3)=0.25

The process of the first to third embodiments is executed by calculating the weight 1 as described above (in the second and third embodiments, the weight is multiplied by wcnt_eg).

As the result of execution of the process described above, a highly accurate survival curve considering both the knowledge of the inspector and the maintenance result can be generated from the fault data group for the parts of which no fault is specified.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A survival curve generating apparatus comprising:
a first generating unit which generates a replace record table indicating, for each of a plurality of parts, an identifier of a part, the number of days the part is used, a fault flag assuming a first value indicating that the part develops or relates to a fault and a second value indicating that the part develops no fault, a group number assuming the same value as other parts related to the same fault and a first weight indicating a uniform degree of effect that the part has on the same fault;
a second generating unit which generates a part fault table indicating, for each of the parts from the replace record table, the number of days used, the fault flag and the first weight;
a third generating unit which generates a survival curve and a hazard function based on the part fault table for each of said plurality of parts;
a determining unit which calculates, for each of the parts in the same group, a hazard value using the hazard function, divides the hazard value of each part by a total hazard value of all the parts in the same group thereby to calculate a second weight, and determines convergence by comparing the first weight and the second weight with each other; and
a control unit which performs a control operation in such a manner that:
the operation is ended by outputting the survival curve when a first result is obtained from the convergence determination;
the first weight is updated with the second weight when a second result is obtained from the convergence determination, and the convergence is determined again by the determining unit after a new survival curve and a new hazard function are generated from the part fault table by the third generating unit using the updated first weight.

2. The apparatus according to claim 1, wherein the third generating unit determines the survival curve and the hazard function by parameter estimation of a Weibull distribution.

3. The apparatus according to claim 1, wherein the first generating unit calculates the first weight by dividing a predetermined value by the number of parts replaced within the same group.

4. The apparatus according to claim 1, wherein the control unit ends the process once the number of loops of the convergence determination exceeds a specified value.

5. The apparatus according to claim 1, further comprising:
a fourth generating unit which generates a frequent faulty part set from the replace record table; and
a total weight calculation unit which calculates the total weight used for the first weight from the replace record table of each of said plurality of parts and the frequent faulty part set.

6. The apparatus according to claim 5, further comprising a table indicating ability of each maintenance person,
wherein the total weight calculation unit calculates the total weight based on the ability of the maintenance person.

7. The apparatus according to claim 1, further comprising a table indicating part fault knowledge,
wherein a replace record table generating unit generates the replace record table for each of said plurality of parts based on the maintenance log and the part fault knowledge.

8. A method of generating a survival curve, comprising:
generating a replace record table indicating, for each of a plurality of parts, an identifier of a part, the number of days the part is used, a fault flag assuming a first value indicating that the part develops or relates to a fault and a second value indicating that the part develops no fault, a group number assuming the same value as other parts related to the same fault and a first weight indicating a uniform degree of effect that the part has on the same fault;
generating a part fault table indicating, for each of the parts from the replace record table, the number of days used, the fault flag and the first weight;
generating the survival curve and the hazard function based on the part fault table for each of said plurality of parts;
determining convergence, for each of the parts in the same group, by calculating a hazard value using the hazard function, dividing the hazard value of each part by a total hazard value of all the parts in the same group thereby to calculate a second weight, and comparing the first weight and the second weight with each other; and
performing a control operation including:
terminating the convergence determination by outputting the survival curve when a first result is obtained; and
updating the first weight with the second weight when a second result is obtained, and generating a new survival curve and a new hazard function from the part fault table using the updated first weight, after which the convergence is determined again.

9. The method according to claim 8, further comprising:
determining the survival curve and the hazard function by parameter estimation of a Weibull distribution.

10. The method according to claim 8, further comprising:
calculating the first weight by dividing a predetermined value by the number of parts replaced within the same group.

11. The method according to claim 8, further comprising:
performing the control operation in such a manner as to end the process once the number of loops of the convergence determination exceeds a specified value.

12. The method according to claim 8, further comprising:
generating a frequent faulty part set from the replace record table; and
calculating the total weight used for the first weight from the replace record table for each of said plurality of parts and the frequent faulty part set.

13. The method according to claim 12, further comprising:
calculating the total weight based on ability of a maintenance person.

14. The method according to claim 8, further comprising:
generating a replace record table for each of said plurality of parts based on the part fault knowledge and the maintenance log.
